(19) United States
(12) Patent Application Publication
(10) Pub. No.: US 2026/0105522 A1
(43) Pub. Date: Apr. 16, 2026

(54) SYSTEM AND METHOD FOR INTELLIGENT GENERATION AND TRACKING OF RESOURCE CHECKPOINTS

(71) Applicant: BANK OF AMERICA CORPORATION, CHARLOTTE, NC (US)

(72) Inventors: Katherine Dintenfass, McLean, VA (US); Charles Phillip Valentine, Charlotte, NC (US); Eytan Alon, Charlotte, NC (US); Jennifer T. Linsenmayer, Davidson, NC (US); Joseph DelVescio, Charlotte, NC (US)

(73) Assignee: BANK OF AMERICA CORPORATION, CHARLOTTE, NC (US)

(21) Appl. No.: 18/915,779

(22) Filed: Oct. 15, 2024

(51) Int. Cl. G06Q 40/06; H04L 67/50

(52) U.S. Cl. CPC G06Q 40/06; H04L 67/535

(57) ABSTRACT

Systems, computer program products, and methods are described herein for intelligent generation and tracking of resource checkpoints. An example system includes a data aggregation subsystem configured to collect data from a user, which is then used by a generative artificial intelligence (AI) subsystem to generate an initial user-specific financial plan. The financial plan includes one or more resource checkpoints tailored to the user's financial goals. The generative AI subsystem may update the financial plan based on feedback provided by the user. A behavior monitoring subsystem continuously tracks user actions and behavior, comparing them to the financial plan. Based on detected patterns, a notification subsystem can transmit preemptive notifications to the user, identifying potential issues or misalignments between the user's actions and their resource checkpoints, providing timely guidance to keep the user on track.

### TECHNOLOGICAL FIELD

The present invention relates to systems and methods for automated financial planning using artificial intelligence (AI), specifically generative AI, in combination with data collection techniques such as zero-party data and big data analytics. The invention further involves real-time tracking of user behavior and providing customized notifications and visualizations of the financial progress.

### BACKGROUND

In the field of financial planning, users often rely on static tools or manual processes to create and manage financial goals over a set timeline. These approaches are often inefficient and unable to adapt dynamically to real-time changes in user behavior or external economic conditions. Additionally, users are frequently required to manually input their data, which leads to a lack of real-time tracking and limited personalized feedback.

Applicant has identified a number of deficiencies and problems associated with tracking resource checkpoints. Many of these identified problems have been solved by developing solutions that are included in embodiments of the present disclosure, many examples of which are described in detail herein.

### BRIEF SUMMARY

Systems, methods, and computer program products are provided for automated financial planning using generative AI.

In one aspect, a system for intelligent generation and tracking of resource checkpoints is presented. The system comprising: a data aggregation subsystem configured to aggregate data from a user; a generative artificial intelligence (AI) subsystem, configured to: generate an initial user-specific financial plan based on the aggregated data, wherein the initial user-specific financial plan comprises one or more resource checkpoints; and update the user-specific financial plan in response to user feedback to the initial user-specific financial plan; a behavior monitoring subsystem configured to continuously monitor user actions and/or user behavior, and compare the user actions and/or user behavior to the user-specific financial plan; and a notification subsystem, configured to: transmit preemptive notifications to the user based on detected patterns of user actions and/or user behavior, wherein the preemptive notifications comprise potential issues related to misalignment of user actions and/or user behavior with the resource checkpoints.

In some embodiments, the data comprises zero-party data gathered directly from the user.

In some embodiments, the data comprises user-provided financial goals.

In some embodiments, the user feedback further enriches a user portfolio used to refine the user-specific financial plan.

In some embodiments, the notification subsystem is further configured to: transmit notifications to the user when deviations from the user-specific financial plan are detected, wherein the notifications further comprise recommendations suggesting adjustments to align the user actions and/or user behavior with the resource checkpoints.

In some embodiments, the system further comprises a prediction subsystem, configured to: predict potential challenges for the user based on historical data from peers in same or similar financial situation as the user; and generate recommendations to the user to avoid and/or resolve the predicted potential challenges.

In some embodiments, the system further comprises a visualization subsystem, configured to: generate a visual representation of the user-specific financial plan, wherein the visual representation shows the user's progress towards achieving the one or more resource checkpoints.

In some embodiments, the visual representation comprises charts, graphs, or other visual elements that reflect completed and pending steps within the user-specific financial plan.

In another aspect, a method for intelligent generation and tracking of resource checkpoints is presented. The method comprising: aggregating, by a data aggregation subsystem, data from a user; generating, using a generative artificial intelligence (AI) subsystem, an initial user-specific financial plan based on the aggregated data, wherein the initial user-specific financial plan comprises one or more resource checkpoints; updating, using the generative AI subsystem, the user-specific financial plan in response to user feedback to the initial user-specific financial plan; continuously monitoring, by a behavior monitoring subsystem, user actions and/or user behavior, and compare the user actions and/or user behavior to the user-specific financial plan; and transmitting, using a notification subsystem, preemptive notifications to the user based on detected patterns of user actions and/or user behavior, wherein the preemptive notifications comprise potential issues related to misalignment of user actions and/or user behavior with the resource checkpoints.

In yet another aspect, a computer program product for intelligent generation and tracking of resource checkpoints is presented. The computer program product comprising a non-transitory computer-readable medium comprising code configured to cause an apparatus to: aggregate, by a data aggregation subsystem, data from a user; generate, using a generative artificial intelligence (AI) subsystem, an initial user-specific financial plan based on the aggregated data, wherein the initial user-specific financial plan comprises one or more resource checkpoints; update, using the generative AI subsystem, the user-specific financial plan in response to user feedback to the initial user-specific financial plan; continuously monitor, by a behavior monitoring subsystem, user actions and/or user behavior, and compare the user actions and/or user behavior to the user-specific financial plan; and transmit, using a notification subsystem, preemptive notifications to the user based on detected patterns of user actions and/or user behavior, wherein the preemptive notifications comprise potential issues related to misalignment of user actions and/or user behavior with the resource checkpoints.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for intelligent generation and tracking of resource checkpoints, in accordance with an embodiment of the invention;

FIG. 2 illustrates an exemplary generative AI subsystem, in accordance with an embodiment of the invention; and

FIG. 3 illustrates a process flow for intelligent generation and tracking of resource checkpoints, in accordance with an embodiment of the invention.

### DETAILED DESCRIPTION

### Overview

Traditional financial planning tools are rigid and do not respond to user behavior in real time. They do not adapt to changes in a user's financial activities or provide dynamic feedback based on collected data. These systems are limited in their ability to help users stay on track with their financial goals, prevent poor financial decisions, or offer insights based on the experiences of other users in similar situations. Additionally, conventional tools often fail to engage users effectively, leading to a disconnect between the financial goals set and the actions taken.

Embodiments of the invention address these shortcomings by introducing a system that generates and continuously updates a user-specific financial plan based on zero-party data collected directly from the user. The system employs generative AI to draft an initial user plan that outlines milestones and financial goals. The system allows the user to provide feedback, which leads to further refinement of the plan and additional data collection to enhance the user portfolio. The system continuously monitors user behavior and actions, comparing the data against the user's financial plan. When deviations from the plan are detected, the system transmits notifications or recommendations to guide the user back on track. For example, the system may notify the user that they have exceeded a budgeted amount in a specific category and suggest adjustments to align with their financial goals. In some embodiments, the system is capable of preemptively notifying users of potential financial missteps, based on detected patterns of behavior, such as browsing history that suggests an impending impulse purchase. Additionally, the system utilizes big data to predict potential challenges based on anonymized historical data from users in similar situations. The system may provide recommendations to help users avoid or resolve these challenges. The invention further employs generative AI to create visual representations of the user's financial progress over time, such as charts or graphs, showing the steps taken towards achieving their goals.

The technical solution described herein improves efficiency by reducing the number of steps required to create and manage a financial plan. The system leverages generative AI to automate plan creation and dynamic updates, which conserves processing and storage resources. Furthermore, the technical solution described herein uses a rigorous, computerized process to perform specific tasks and/or activities that were not previously performed. In specific implementations, the technical solution bypasses a series of steps previously implemented, thus further conserving computing resources. By providing more accurate predictions and recommendations, the system reduces the resources required to remedy errors, such as overuse of processing power or bandwidth to correct misaligned financial plans. Additionally, by optimizing the amount of data processed at each stage, the system minimizes network traffic and reduces the load on computing infrastructure.

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, satisfied, etc.

### Example System Environment

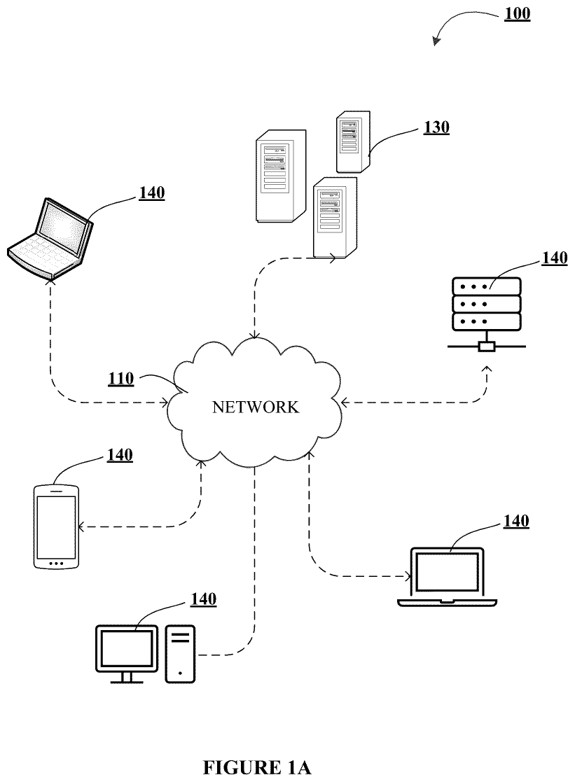

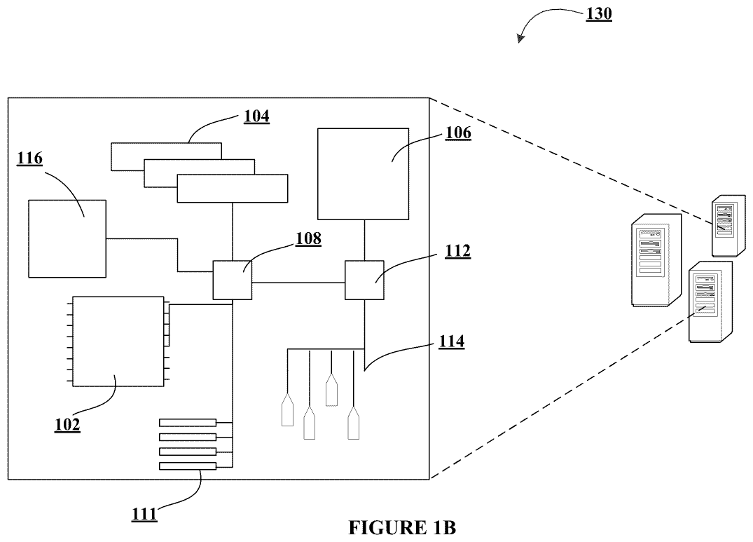

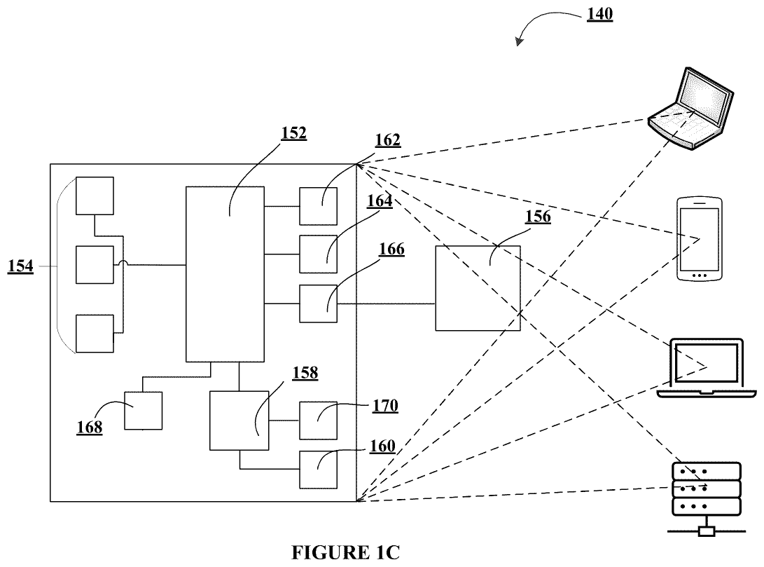

FIGS. 1A-1C illustrate technical components of an exemplary distributed computing environment for intelligent generation and tracking of resource checkpoints 100, in accordance with an embodiment of the invention. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file servers, or the like, as well as a range of digital computing devices, including laptops, desktops, video recorders, audio/video players, radios, workstations, and/or the like. Additionally, system 130 may include a variety of auxiliary network devices, encompassing wearable devices, Internet-of-things (IoT) devices, electronic kiosk devices, entertainment consoles, mainframes, and/or the like, in any combination to cater to the complexity and diversity of contemporary digital ecosystems.

The end-point device(s) 140 may encompass an array of electronic devices, such as personal digital assistants, cellular telephones, smartphones, laptops, desktops, and merchant input devices like point-of-sale (POS) systems, electronic payment kiosks, and automated teller machines (ATMs). End-point device(s) 140 may also include edge devices like routers, routing switches, integrated access devices (IAD), and/or the like, and devices capable of interfacing with 5G networks, delivering enhanced data processing and connectivity.

The network 110 may include a distributed network architecture that spans a variety of network types, facilitating a cohesive data communication network that can be managed jointly or individually. The network architecture supports shared communication as well as distributed processing across platforms such as telecommunication networks, local area networks (LAN), wide area networks (WAN), global area networks (GAN), the Internet infrastructure, and/or the like. Network 110 may also integrate emerging networking technologies, including software-defined networking (SDN), network function virtualization (NFV), and next-generation wireless communication standards like 5G. Network 110 may employ secure or unsecure, as well as wireless, wired, and optical interconnection technologies, and/or the like, to accommodate a spectrum of communication and processing needs.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

In some embodiments, examples of subsystems may include a data aggregation subsystem, a generative AI subsystem, a behavior monitoring subsystem, a notification subsystem, a prediction subsystem, and a visualization subsystem.

The data aggregation subsystem may be configured to collect and aggregate data directly from the user. This data may include zero-party data provided by the user, such as financial goals, spending patterns, incoming funds, and other relevant resource information. The data aggregation subsystem may retrieve this information through direct user input or automated collection methods, including integration with external systems or platforms, such as financial tools, banking systems, personal budgeting applications, or the like. The data aggregation subsystem may employ secure methods of data transfer and storage to ensure the integrity and privacy of the user's data. The data aggregation subsystem may also support multiple data formats and collection intervals, allowing for continuous or periodic updates of the user's financial information.

The generative AI subsystem may be responsible for generating an initial user-specific financial plan based on the data aggregated by the data acquisition subsystem. The initial user-specific financial plan may include one or more resource checkpoints, which represent specific milestones or goals the user seeks to achieve. The generative AI subsystem may dynamically update the financial plan based on user feedback, adjusting the resource checkpoints as new information becomes available or as the user refines their goals. The generative AI subsystem may analyze patterns in the user's data to create personalized recommendations, ensuring that the financial plan is tailored to the user's specific circumstances and preferences. The generative AI subsystem may also simulate future scenarios to account for potential changes in user behavior or external financial factors.

The behavior monitoring subsystem may continuously track and analyze the user's actions and behavior to determine whether these actions align with the user-specific financial plan. The behavior monitoring subsystem may compare real-time data on user spending, saving habits, or other financial activities against the established resource checkpoints. The behavior monitoring subsystem may also detect deviations from the plan, identifying areas where the user's behavior may not be in alignment with the goals outlined in the financial plan. The behavior monitoring subsystem may capture these discrepancies and trigger appropriate responses, such as adjustments to the financial plan or notifications to the user, based on the extent and nature of the misalignment.

The notification subsystem may be responsible for delivering notifications to the user based on the findings of the behavior monitoring subsystem. The notification subsystem may transmit preemptive notifications to alert the user to potential issues or misalignments between their actions and the established resource checkpoints. These notifications may provide real-time feedback on spending habits, suggest adjustments, or warn the user of potential financial pitfalls based on detected patterns in their behavior. The notification subsystem may also transmit corrective notifications when specific deviations from the user-specific financial plan are detected, offering actionable recommendations to guide the user back on track towards achieving their resource checkpoints.

The prediction subsystem may be configured to identify potential challenges that could arise during the user's pursuit of their financial goals. The prediction subsystem may analyze anonymized historical data from users in similar financial situations to predict possible obstacles, such as budget constraints, spending habits, or unexpected financial events. The prediction subsystem may generate recommendations to help the user avoid or resolve these challenges before they materialize. By leveraging insights from big data, the prediction subsystem may provide forward-looking advice that anticipates potential disruptions to the user's financial progress.

The visualization subsystem may generate visual representations of the user-specific financial plan, enabling the user to track their progress towards achieving one or more resource checkpoints. These visualizations may include charts, graphs, or other graphical elements that display the user's current financial standing relative to their goals. The visualization subsystem may highlight completed milestones, pending tasks, and any adjustments made to the plan over time. The visualization subsystem may allow the user to interact with the visual elements to explore different aspects of their financial plan, offering an intuitive and accessible view of their financial progress.

In some embodiments, the subsystems, including the data aggregation subsystem, generative AI subsystem, behavior monitoring subsystem, notification subsystem, prediction subsystem, and visualization subsystem, may function in a coordinated manner, facilitating an iterative data processing loop in which user data is continuously acquired, processed, and analyzed to dynamically generate and refine personalized financial recommendations and progress assessments.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

### Example Generative Artificial Intelligence (AI) Subsystem

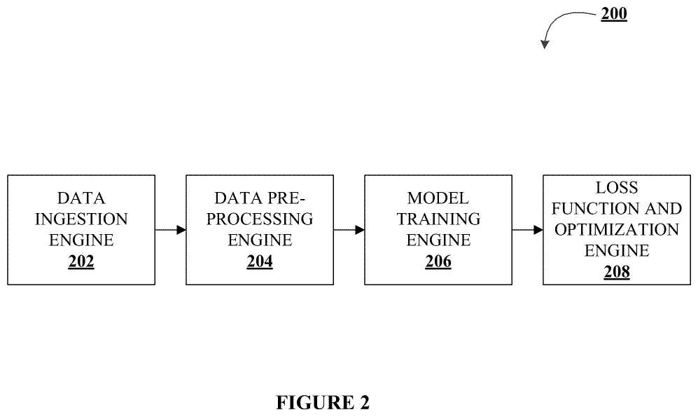

FIG. 2 illustrates an exemplary generative AI subsystem 200, in accordance with an embodiment of the invention. The generative AI subsystem 200 may include a data ingestion engine 202, a data pre-processing engine 204, a model training engine 206, and a loss function and optimization engine 208. It should be understood that the generative AI subsystem 200 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 200 should not be considered limiting and may be adapted to various configurations within the scope of the invention.

The data ingestion engine 202 may identify various internal and/or external data sources to generate, test, and/or integrate new features for training the generative AI model. These internal and/or external data sources (e.g., text corpora, web-based text data, document repositories, or decentralized text storage system) may be initial locations where the data originates or where physical information is first digitized. In addition to conventional data sources, the data ingestion engine 202 may support decentralized storage systems, such as blockchain-based data sources, and privacy-preserving methods such as differential privacy. The data ingestion engine 202 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like.

Depending on the nature of the data, the data ingestion engine 202 may move the data to a destination for storage or further analysis. Typically, the data may be in varying formats as they come from different sources, including RDBMS, other types of databases, S3 buckets, CSVs, or from streams. For a large language model (“LLM”), text data may originate from sources such as web scrapes, social media, large public text datasets, or the like. Since the data comes from different places, it needs to be cleansed and transformed so that it can be analyzed together with data from other sources. The data may be ingested in real-time, using stream processing, in batches using a batch data warehouse, or a combination of both. Stream processing may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse collects and transfers data in batches according to scheduled intervals, trigger events, or any other logical ordering.

In machine learning, the quality of data and the useful information that can be derived therefrom directly affects the ability of the machine learning model to learn. The data pre-processing engine 204 may implement advanced integration and processing steps needed to prepare the data for machine learning execution, including tokenization, text normalization, and removal of irrelevant elements like HTML tags in web-based data, especially for LLM training. This may include modules to perform any upfront, data transformation to consolidate the data into alternate forms by changing the value, structure, or format of the data using generalization, normalization, attribute selection, and aggregation, text-specific transformations such as stemming and lemmatization, data cleaning by filling missing values, smoothing the noisy data, resolving the inconsistency, and removing outliers, and/or any other encoding steps as needed. In some embodiments, the data pre-processing engine 204 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 204 may transform categorical data into numerical formats that are suitable for machine learning algorithms. In this regard, the data pre-processing engine 204 may use techniques such as one-hot encoding or label encoding depending on the nature of the categorical variables and the intended use of the data.

In some embodiments, the data pre-processing engine 204 may also include dimensionality reduction techniques, where the number of input features is reduced while retaining the most relevant information. In this regard, the data pre-processing engine 204 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 204 may then be fed into the model training module 206.

The model training engine 206 may be responsible for training the generative AI models using the pre-processed data from the data pre-processing engine 204. The model training engine 206 may implement various machine learning algorithms, including but not limited to Generative Adversarial Networks (GANs), Variational Autoencoders (VAEs), transformers, diffusion models, or other specialized architectures depending on the specific requirements of the system. These models may be used in a broad range of applications, such as LLMs for text generation, image generation models, video synthesis models, audio generation models, and/or the like. The model training engine 206 may optimize these models by continuously adjusting their internal parameters based on the patterns and relationships identified within the data.

In some embodiments, the model training engine 206 may include a training data handler, which manages the partitioning of the pre-processed data into training, validation, and testing datasets. The training data is used to update the model's parameters, while the validation and testing datasets are reserved to evaluate the model's performance during and after training. The model training engine 206 may support various data-handling strategies, such as cross-validation or random shuffling, to ensure that the model generalizes well and is not overfitting to the training data.

In embodiments involving large language models, the model training engine 206 may utilize transformer-based architectures, such as the Transformer, BERT, GPT, or the like. Transformer models rely on mechanisms like self-attention to capture dependencies between words in a sequence, regardless of their distance from one another. The self-attention mechanism allows the model to weigh the importance of different words in a sentence and establish complex relationships important for understanding context. During training, the model may process vast amounts of text data and learn to predict the next word or token in a sequence based on the input context. This training process allows LLMs to generate coherent text, complete sentences, translate languages, or answer questions based on learned patterns from the data.

The transformer-based LLMs may be trained using autoregressive (e.g., GPT) or masked-language modeling techniques (e.g., BERT). In autoregressive models, the training process may include predicting the next word in a sequence by progressively revealing more context to the model. The model iteratively improves its predictions based on its performance during prior iterations. Masked-language modeling involves masking certain words in a sentence and training the model to correctly predict the masked words based on surrounding context. Both approaches enable LLMs to capture intricate patterns in human language, improving their ability to handle tasks such as summarization, translation, and text generation. Loss functions like cross-entropy loss may be used to optimize the model's performance by comparing predicted tokens with the actual tokens in the dataset to guide the model to minimize prediction errors during training.

In embodiments involving image generation models, the model training engine 206 may utilize transformer-based architectures, such as Vision Transformers (ViTs) or generative adversarial networks (GANs). Vision Transformers rely on self-attention mechanisms to process images as sequences of patches rather than whole images, allowing the model to capture spatial dependencies and patterns across the image. During training, the model may be exposed to large datasets containing diverse image types to learn features like textures, edges, and shapes. The model may then generate or reconstruct images by interpreting these patterns and applying learned spatial relationships. GAN-based models may also be used, where a generator network creates images, and a discriminator network evaluates their realism, enabling the model to improve through adversarial training.

Image generation models may employ various training techniques, such as pixel-wise reconstruction or adversarial training, depending on the architecture. Pixel-wise reconstruction methods involve learning to reconstruct an image from its corrupted or downscaled version, optimizing the model to minimize the difference between the predicted and actual pixels (e.g., using mean squared error as the loss function). Adversarial training, often used with GANs, involves iteratively improving the generator network to produce images that are increasingly indistinguishable from real images, based on feedback from the discriminator network. These approaches allow the model to capture complex visual features, enabling applications such as image synthesis, enhancement, and style transfer.

For video generation models, the model training engine 206 may employ transformer-based architectures like Video Transformers or GAN-based models specifically designed for handling temporal sequences. Video Transformers use self-attention mechanisms to model dependencies not only between pixels within a single frame but also across frames, allowing them to understand temporal relationships and motion patterns in videos. The model may be trained on large video datasets, enabling it to learn and reproduce dynamic changes and interactions between objects over time. GAN-based video models may incorporate spatiotemporal networks to evaluate the realism of generated video sequences, optimizing the model to produce continuous and coherent frames.

Video generation models may utilize spatial-temporal modeling techniques or adversarial training for generating realistic motion and video sequences. Spatial-temporal modeling involves learning the spatial features within each frame while simultaneously capturing the temporal dependencies between frames, optimizing the model's ability to predict future frames or complete missing sequences. Loss functions like mean squared error or perceptual loss may be applied to reduce discrepancies between predicted and actual frames. Adversarial training, on the other hand, may involve a generator creating video sequences and a discriminator evaluating their realism, encouraging the generator to improve by minimizing the discrepancy identified by the discriminator. These techniques may enable video generation models to create coherent and realistic sequences, useful in applications such as video synthesis and animation.

In audio generation models, the model training engine 206 may utilize architectures such as Audio Transformers or recurrent neural networks (RNNs) like WaveNet, designed to handle sequential and waveform data. Audio Transformers leverage attention mechanisms to capture relationships between segments of audio, allowing them to model temporal dependencies and predict the next audio sample based on previous context. During training, the model may process large audio datasets containing diverse sound patterns to learn representations of different audio features, such as frequency, amplitude, and harmonics. This training enables the model to generate coherent audio sequences, including speech, music, or ambient sounds, by synthesizing these learned patterns.

Audio generation models may be trained using sequence modeling techniques or autoregressive methods, depending on the architecture. Sequence modeling techniques involve processing and predicting sequences of audio samples, optimizing the model to capture and reproduce temporal dependencies in sound. Autoregressive methods, such as those employed in WaveNet, focus on predicting each audio sample based on prior samples, progressively refining the generated audio sequence over multiple iterations. Loss functions like mean absolute error or cross-entropy loss may be used to minimize the error between predicted and actual audio samples, guiding the model to improve its accuracy. These approaches allow audio generation models to create continuous and realistic audio outputs, applicable in areas such as speech synthesis, music generation, and sound effect creation.

The reconstruction loss ensures that the difference between the original input and the reconstructed output is minimized, guiding the decoder to generate outputs that closely resemble the input data. The second component, KL divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models, the model training engine 206 may implement optimization techniques such as gradient clipping, learning rate scheduling, and mixed-precision training. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float32) for specific calculations, may be used to accelerate training and reduce memory consumption, enabling the model to scale efficiently even when trained on large datasets.

In some embodiments, the model training engine 206 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 206 may also support distributed training across multiple computing nodes, allowing the system to scale its computational resources as needed. Distributed training may involve splitting the generative AI model and data across multiple machines or GPUs, where each node processes a portion of the data and updates the model in parallel. This is particularly useful for large datasets or models that require significant computational power, such as deep generative models. The model training engine 206 may synchronize the updates across the nodes using techniques like synchronous or asynchronous gradient descent.

Once the generative AI model is trained, the model training engine 206 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 206 may also implement transfer learning, where a pre-trained model is fine-tuned on a smaller, domain-specific dataset. This may reduce the amount of time and data required to train a new model, especially in cases where the available data is limited or highly specialized. The model training engine 206 may adjust the parameters of the pre-trained model to better align with the new dataset, while preserving the learned features from the original training.

In embodiments involving LLMs, new output is generated by sampling from the model's probability distribution of tokens, conditioned on the context provided as input. Transformer-based architectures, such as GPT, use an auto-regressive approach where the model predicts the next token in a sequence one step at a time, using previously generated tokens as input for subsequent predictions. The process starts with a prompt or an initial sequence of words, and the model iteratively generates new tokens, forming coherent sentences or paragraphs based on the learned context and language patterns. For masked-language modeling (e.g., BERT), new output may be generated by filling in masked parts of the input sequence, allowing the model to complete sentences or generate variations of the provided text. The generated output can be controlled by adjusting parameters such as temperature, which influences the randomness of the token sampling, enabling the generation of diverse or deterministic responses.

In image generation models, such as those using ViTs or GANs, new output is generated by sampling from the learned distribution in the model's latent space. For GANs, the generator network creates an image by transforming random noise vectors into structured image outputs through a series of layers that learn visual features like shapes, textures, and colors. The generated image is then refined through adversarial feedback from the discriminator network, which assesses the realism of the generated output. For transformer-based image models, the process may involve reconstructing images by assembling patches based on the learned dependencies between them. Input conditions, such as prompts describing desired features or specific noise vectors, guide the generation process, allowing for the creation of customized images or variations of existing visual styles. These models may also generate images based on style transfer techniques or predefined templates, synthesizing images that align with the characteristics present in the training data.

Video generation models utilize spatiotemporal dependencies to synthesize new video sequences based on the patterns learned during training. In transformer-based architectures, the model may generate video frames sequentially, predicting the next frame based on the input frames and the temporal context established by prior frames. GAN-based models, specifically designed for video synthesis, may sample noise vectors or use a sequence of frames as input, transforming these into continuous and temporally coherent video outputs through the generator network. The discriminator evaluates the temporal consistency and realism of the output, ensuring the generated video mimics the motion dynamics and object interactions present in real-world video data. Such models may also use attention mechanisms to focus on critical elements within each frame and their evolution across time, facilitating realistic scene transitions and motion patterns. The generation process may include user-defined input such as initial frames, motion descriptions, or specific video attributes, providing control over the output.

Audio generation models, including Audio Transformers or autoregressive architectures like WaveNet, generate new audio sequences by predicting audio samples based on learned dependencies in sequential sound data. For autoregressive models, the generation process involves producing each audio sample one at a time, conditioned on previously generated samples, allowing the model to build complex audio patterns such as speech, music, or ambient sounds. The model starts with an initial segment or a random seed and uses its learned parameters to predict and synthesize subsequent samples, constructing a continuous audio waveform. Audio Transformers, on the other hand, may use attention mechanisms to identify important temporal segments within the input audio and synthesize new output based on these learned patterns. The user can control the type of audio generated by providing parameters such as pitch, tempo, or initial sound clips, enabling the model to generate outputs tailored to specific use cases like speech synthesis, music composition, or environmental sound generation.

In some embodiments, generative AI models may also integrate multiple modalities, enabling cross-modal generation where output in one modality influences or conditions the generation in another. For example, a video generation model may use text descriptions as input, synthesizing video content that aligns with the specified narrative or visual scene described. Similarly, image generation models may generate visual representations based on audio inputs, such as generating animations synchronized to musical rhythms or speech patterns. These cross-modal systems typically involve conditional GANs or multi-modal transformers, where the model processes input from one domain (e.g., text or audio) and learns to generate output in another domain (e.g., video or image) by aligning the patterns and dependencies between the different modalities. These models may allow users to generate complex, multimodal content based on combinations of inputs, such as using textual prompts to control the visual and auditory elements of a video.

It will be understood that the embodiment of the generative AI subsystem 200 illustrated in FIG. 2 is exemplary and that other embodiments may vary. The generative AI subsystem 200, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

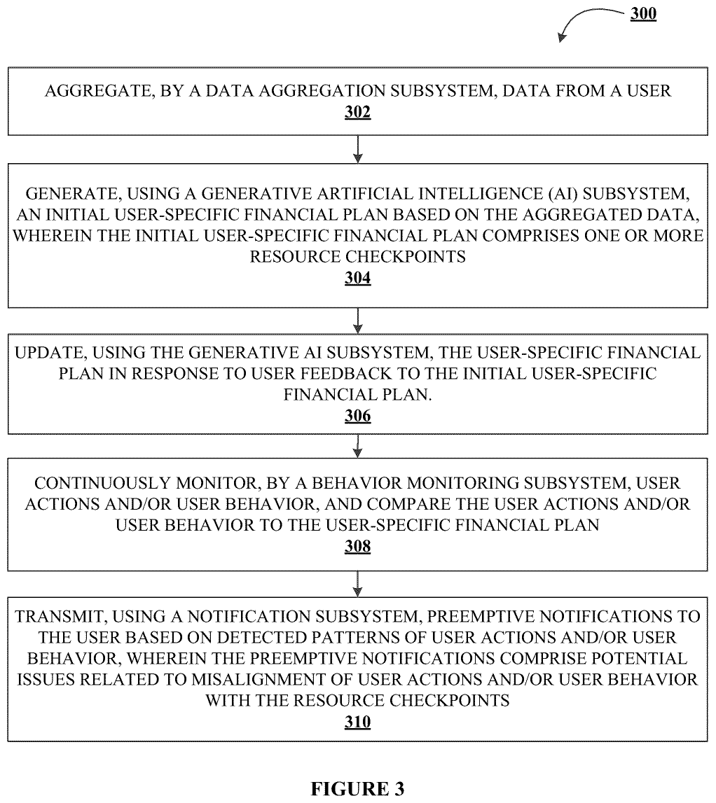

FIG. 3 illustrates a process flow 300 for intelligent generation and tracking of resource checkpoints, in accordance with an embodiment of the invention. The method 300 may be executed by a system (e.g., system 130), which may include multiple subsystems such as a data aggregation subsystem, a generative AI subsystem, a behavior monitoring subsystem, a notification subsystem, and optionally, a prediction subsystem and visualization subsystem. These subsystems may work in coordination to perform the various steps of the method, ensuring that user data is accurately aggregated, processed, and used to generate personalized financial plans. Each of these subsystems may be implemented as software, hardware, or a combination thereof, and may operate on a cloud-based platform, local servers, or edge devices, depending on the system configuration.

As shown in block 302, the process flow includes aggregating, by a data aggregation subsystem, data from a user. In some embodiments, this data may include a wide range of inputs provided directly by the user, such as financial goals, incoming funds, expenses, and other personal financial information. The data aggregation subsystem may also collect data from external sources such as financial institutions, credit reporting agencies, or investment platforms with user authorization. In other embodiments, the data aggregation subsystem may collect zero-party data, which is data intentionally provided by the user, such as their stated financial objectives (e.g., “I want to save $20,000 for a down payment in two years”). The system may also support the aggregation of user-provided financial goals, including savings targets, investment preferences, and exposure tolerance levels.

The data aggregation subsystem may utilize a variety of techniques to collect and integrate data. For example, data may be gathered via APIs from external financial institutions or uploaded directly by the user through a web interface. Additionally, the system may support secure data transmission protocols such as File Transfer Protocol (FTP) or Hyper-Text Transfer Protocol (HTTP) for accessing third-party data services. In some cases, decentralized storage systems such as blockchain-based platforms may be used for secure and privacy-preserving data sharing, ensuring data integrity and privacy. The data aggregation subsystem may also integrate edge computing devices that collect real-time data (such as expenditures or transaction data from mobile banking applications), which are then transmitted to the central system for processing.

In certain embodiments, the data aggregation subsystem may employ privacy-enhancing techniques, such as differential privacy or data anonymization, to ensure that sensitive financial information remains protected while still allowing the system to perform relevant analyses. These methods may ensure compliance with privacy regulations such as the General Data Protection Regulation (GDPR) and other data protection laws. Additionally, the data aggregation subsystem may handle data in various formats, including structured formats (e.g., CSV, JSON, or XML), as well as unstructured data sources, such as text-based inputs or scanned documents containing financial information. In embodiments where unstructured data is provided, the system may include data parsing modules or optical character recognition (OCR) technologies to extract meaningful information and convert it into structured formats suitable for analysis.

The aggregation step may also include validating the data to ensure accuracy and completeness. For instance, the system may cross-check inputted data with external sources or historical data to detect inconsistencies or errors in the user-provided information. The validated data is then processed and transmitted to the generative AI subsystem for the next step in the process, where it will be used to generate a personalized financial plan tailored to the user's inputs. In alternative embodiments, the data aggregation subsystem may also interface with external predictive systems or financial forecasting tools, allowing the system to incorporate additional external insights into the user's financial behavior. These integrations can be useful for real-time financial tracking, where continuous data is collected from multiple sources and updated in near real-time, enabling more dynamic and responsive financial planning.

As shown in block 304, the process flow includes generating, using a generative artificial intelligence (AI) subsystem, an initial user-specific financial plan based on the aggregated data, wherein the initial user-specific financial plan comprises one or more resource checkpoints. The generative AI subsystem may utilize the data collected by the data aggregation subsystem to understand the user's financial goals, incoming funds, expenses, and other relevant financial behaviors. As described herein, the generative AI subsystem may apply various machine learning models to analyze the aggregated data and create a tailored financial plan that is aligned with the user's specific financial situation and goals.

The initial financial plan generated by the system may include one or more resource checkpoints, which represent key milestones or financial targets the user is encouraged to achieve over a given period. For example, a resource checkpoint might include savings goals, such as accumulating a certain amount in an emergency fund, or fund reduction targets, such as paying off a specific percentage of credit card funds within a set timeframe. These checkpoints serve as actionable steps that guide the user towards their broader financial goals, ensuring that the plan is broken down into manageable, achievable milestones.

The generative AI subsystem may base the financial plan on patterns learned from the user's specific data and historical financial data from other users in similar financial situations. It may also incorporate predictive models to project the user's future financial needs, allowing for more accurate and relevant resource checkpoints. The system can adjust these checkpoints dynamically, depending on changes in the user's financial status, market conditions, or other external factors.

In some embodiments, the generative AI subsystem may also take into account exposure tolerance, investment preferences, and other individualized factors when generating the initial financial plan. For instance, a user with a higher exposure tolerance may be presented with a more aggressive investment strategy, while a user with a low-exposure tolerance may see more conservative options. The initial plan serves as the baseline for the user's financial journey, and the system can update it over time in response to user feedback or behavioral changes, as described in subsequent steps. This plan not only provides the user with a clear roadmap of what actions to take but also ensures that these actions are aligned with their long-term financial goals.

As shown in block 306, the process flow includes updating, using the generative AI subsystem, the user-specific financial plan in response to user feedback to the initial user-specific financial plan. After the system generates the initial plan, the user may review the suggested financial goals, resource checkpoints, and associated actions. The system allows the user to provide feedback, which may include modifications to the proposed financial targets, adjustment of timelines, or the prioritization of certain financial goals over others (e.g., increasing savings contributions or reallocating funds for repayment). In this way, the system may continuously enrich the user portfolio based on the feedback provided by the user during the financial planning process. For example, if a user initially indicates a preference for conservative investments but later expresses interest in more aggressive strategies, the system updates the user portfolio to reflect this change, enabling the financial plan to be adapted accordingly. The enriched user portfolio may incorporate a variety of data points, including personal financial objectives, incoming fund changes, exposure tolerance levels, and historical user behaviors.

The generative AI subsystem dynamically incorporates this user feedback to refine the financial plan, such that it remains aligned with the user's preferences, real-time financial situation, and priorities. The feedback loop enables the system to move beyond static financial plans by continuously adapting to user input. For example, if a user prefers to save more aggressively for a short-term goal (e.g., saving for a house deposit), the system can adjust the resource checkpoints to increase savings allocation towards that goal, while modifying other checkpoints, such as reducing discretionary spending. The system may also track trends in the user's feedback over time, allowing for a more accurate and personalized financial plan. As the user portfolio becomes more detailed, the system can provide more tailored recommendations and adjustments to the financial plan, improving the relevance and precision of the resource checkpoints.

In some embodiments, the updated financial plan may also involve further recalibration of the resource checkpoints based on the feedback. For instance, if the user indicates they want to achieve a specific milestone sooner (e.g., accelerating funds repayment), the system can adjust the timeline for that checkpoint while generating new recommendations for budget adjustments, fund reallocation, or spending cuts to make this goal feasible.

The system may also collect additional zero-party data during this feedback process, further enriching the user portfolio. This data may include the user's evolving financial objectives, changes in personal circumstances (e.g., changes in incoming funds or expenses), or behavioral insights such as exposure tolerance shifts. The updated user portfolio allows the generative AI subsystem to better tailor the financial plan to the user's real-time preferences and needs.

By processing feedback iteratively, the generative AI subsystem can continually optimize the financial plan, ensuring it remains personalized and actionable as the user's financial situation and goals evolve. Such a flexible, user-responsive system configuration may help ensure that users are empowered to take proactive steps toward achieving their financial objectives, while remaining adaptable to their changing needs.

As shown in block 308, the process flow includes continuously monitoring, by a behavior monitoring subsystem, user actions and/or user behavior, and compare the user actions and/or user behavior to the user-specific financial plan. The behavior monitoring subsystem may track various types of financial activities, such as spending patterns, savings deposits, incoming fund fluctuations, and investment transactions. This data may be collected in real-time or at regular intervals from various sources, including bank accounts, credit card transactions, investment portfolios, and other financial platforms to provide a comprehensive view of the user's financial behavior.

The behavior monitoring subsystem continuously analyzes the user's actions to ensure that they are aligned with the resource checkpoints and milestones outlined in the user-specific financial plan. For example, if the user has set a goal to save a certain amount each month, the behavior monitoring subsystem may track their savings contributions and expenditures to determine whether the user is on track to meet that goal. If the system detects that the user is spending more than anticipated in discretionary categories (e.g., entertainment or dining), it may flag these deviations as potential exposures to achieving the financial plan's objectives.

In some embodiments, the behavior monitoring subsystem may integrate with external financial APIs or platforms to gather real-time transaction data, allowing it to detect spending behavior as it happens. The system may then compare this data to the predefined benchmarks or resource checkpoints in the user-specific financial plan, providing ongoing insight into how well the user is adhering to their plan.

In addition to tracking financial transactions, the behavior monitoring subsystem may also analyze non-financial behavior that impacts the user's financial health, such as browsing patterns that indicate impulse purchasing tendencies or delayed bill payments that could impact cash flow. By analyzing both direct financial data and behavioral indicators, the subsystem provides a holistic view of the user's financial actions in relation to their overall goals.

If significant deviations from the plan are detected, the behavior monitoring subsystem can flag these discrepancies and trigger subsequent actions by the system, such as generating notifications or recommendations to help the user get back on track. This ensures that the system remains proactive, continuously assessing user behavior to facilitate the timely adjustments needed to align with their long-term financial goals. This real-time monitoring also helps the system adapt the financial plan as the user's actions evolve, ensuring a flexible and responsive planning process.

As shown in block 310, the process flow includes transmitting, using a notification subsystem, preemptive notifications to the user based on detected patterns of user actions and/or user behavior, wherein the preemptive notifications comprise potential issues related to misalignment of user actions and/or user behavior with the resource checkpoints. The notification subsystem may analyze data collected by the behavior monitoring subsystem and identify patterns or trends in the user's actions that suggest a divergence from their user-specific financial plan. For example, if the system detects an increase in discretionary spending that exceeds the limits set in the user's financial plan, it may trigger a notification warning the user that this behavior could negatively impact their ability to achieve a particular savings goal or meet fund repayment targets.

In some embodiments, the notification subsystem may employ machine learning algorithms to predict future deviations based on past behavior patterns, enabling it to provide proactive alerts before the user strays too far from their resource checkpoints. These preemptive notifications may include detailed information about the detected issue, such as the specific spending category that has exceeded the user's budget, or an alert regarding below target savings contributions for a particular month. Notifications can be delivered through a variety of channels, including email, text messages, mobile app notifications, or dashboard alerts, depending on the user's preferences. The notifications may also offer recommendations for corrective actions, such as reducing spending in certain categories, reallocating funds, or adjusting the financial plan to accommodate changes in the user's incoming funds or expenses.

For example, if a user is falling behind on their fund repayment checkpoint, the system might notify them and recommend increasing their next payment or cutting back on non-essential expenditures to stay on track. Similarly, if the system detects that the user is about to make an impulse purchase based on their browsing history or transaction patterns, it might issue a notification suggesting they reconsider the purchase in light of their long-term financial goals.

The notification subsystem's ability to send preemptive alerts helps the user stay informed of potential financial exposures and empowers them to take proactive steps to realign their actions with their financial plan. This ongoing feedback loop ensures that the user remains engaged with their financial goals and is better equipped to achieve them in a timely and efficient manner.

In some embodiments, the system may include a prediction subsystem configured to anticipate potential financial challenges that the user may encounter. The prediction subsystem may analyze historical data from peers in similar financial situations, such as users with comparable levels of incoming funds, financial goals, or spending habits. By leveraging this historical data, the prediction subsystem can identify patterns or trends that indicate potential exposures, such as cash flow shortages, unexpected expenses, or missed savings goals. For example, if historical data shows that users in similar financial situations tend to overspend during certain times of the year, the system may predict a similar challenge for the current user and generate preemptive recommendations.

The prediction subsystem may also use machine learning algorithms to analyze the user's own financial data, combined with the peer data, to forecast potential deviations from the financial plan. Based on these predictions, the system can generate actionable recommendations to help the user avoid or mitigate these challenges. For example, if the system predicts that the user may struggle to meet a savings goal due to high discretionary spending, it may recommend reducing non-essential expenses or reallocating funds to ensure the savings target is met. These predictive insights help the user stay proactive in managing their finances, minimizing the likelihood of significant deviations from their resource checkpoints.

In certain embodiments, the system may include a visualization subsystem that generates visual representations of the user-specific financial plan and the user's progress toward achieving their resource checkpoints. The visualization subsystem may display charts, graphs, or other visual elements that provide a clear, user-friendly view of the user's financial journey. For example, a progress bar may show how much the user has saved towards a specific goal, such as an emergency fund, or a graph may display monthly savings contributions over time compared to the target savings rate. The visual representations may also highlight the completed and pending steps within the financial plan, allowing the user to easily track their progress. In some embodiments, the visualization subsystem may update these visual elements in real-time, reflecting the latest financial actions taken by the user and any adjustments made to the financial plan. For instance, if the user makes a large contribution to their savings, the system may immediately update the progress bar to reflect this achievement, helping the user stay motivated and focused on their financial objectives. Additionally, the visualization subsystem may generate alerts or visual cues when deviations from the plan are detected, such as a warning icon next to a financial goal that is at the exposure of not being met. This real-time feedback, combined with intuitive visual elements, ensures that users are continuously informed about their financial status and can take corrective action when necessary. By providing these insights in a visually accessible format, the system empowers users to make informed decisions and stay aligned with their long-term financial goals.

Embodiments of the present disclosure are described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the methods described above may include fewer steps in some cases, while in other cases the methods may include additional steps. The steps of the methods and modifications to the steps of the methods described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for intelligent generation and tracking of resource checkpoints, the system comprising:
a data aggregation subsystem configured to aggregate data from a user;
a generative artificial intelligence (AI) subsystem, configured to:
generate an initial user-specific financial plan based on the aggregated data, wherein the initial user-specific financial plan comprises one or more resource checkpoints; and
update the user-specific financial plan in response to user feedback to the initial user-specific financial plan;
a behavior monitoring subsystem configured to continuously monitor user actions and/or user behavior, and compare the user actions and/or user behavior to the user-specific financial plan; and
a notification subsystem, configured to:
transmit preemptive notifications to the user based on detected patterns of user actions and/or user behavior, wherein the preemptive notifications comprise potential issues related to misalignment of user actions and/or user behavior with the resource checkpoints.

2. The system of claim 1, wherein the data comprises zero-party data gathered directly from the user.

3. The system of claim 1, wherein the data comprises user-provided financial goals.

4. The system of claim 1, wherein the user feedback further enriches a user portfolio used to refine the user-specific financial plan.

5. The system of claim 1, wherein the notification subsystem is further configured to:
transmit notifications to the user when deviations from the user-specific financial plan are detected, wherein the notifications further comprise recommendations suggesting adjustments to align the user actions and/or user behavior with the resource checkpoints.

6. The system of claim 1, further comprising a prediction subsystem, configured to:
predict potential challenges for the user based on historical data from peers in same or similar financial situation as the user; and
generate recommendations to the user to avoid and/or resolve the predicted potential challenges.

7. The system of claim 1, further comprising a visualization subsystem, configured to:
generate a visual representation of the user-specific financial plan, wherein the visual representation shows the user's progress towards achieving the one or more resource checkpoints.

8. The system of claim 7, wherein the visual representation comprises charts, graphs, or other visual elements that reflect completed and pending steps within the user-specific financial plan.

9. A method for intelligent generation and tracking of resource checkpoints, the method comprising:
aggregating, by a data aggregation subsystem, data from a user;
generating, using a generative artificial intelligence (AI) subsystem, an initial user-specific financial plan based on the aggregated data, wherein the initial user-specific financial plan comprises one or more resource checkpoints;
updating, using the generative AI subsystem, the user-specific financial plan in response to user feedback to the initial user-specific financial plan;
continuously monitoring, by a behavior monitoring subsystem, user actions and/or user behavior, and compare the user actions and/or user behavior to the user-specific financial plan; and
transmitting, using a notification subsystem, preemptive notifications to the user based on detected patterns of user actions and/or user behavior, wherein the preemptive notifications comprise potential issues related to misalignment of user actions and/or user behavior with the resource checkpoints.

10. The method of claim 9, wherein the data comprises zero-party data gathered directly from the user.

11. The method of claim 9, wherein the data comprises user-provided financial goals.

12. The method of claim 9, wherein the user feedback further enriches a user portfolio used to refine the user-specific financial plan.

13. The method of claim 9, wherein the method further comprises:
transmitting, using the notification subsystem, notifications to the user when deviations from the user-specific financial plan are detected, wherein the notifications further comprise recommendations suggesting adjustments to align the user actions and/or user behavior with the resource checkpoints.

14. The method of claim 9, wherein the method further comprises:
predicting, using a prediction subsystem, potential challenges for the user based on historical data from peers in same or similar financial situation as the user; and
generating, using the prediction subsystem, recommendations to the user to avoid and/or resolve the predicted potential challenges.

15. The method of claim 9, wherein the method further comprises:
generating, using a visualization subsystem, a visual representation of the user-specific financial plan, wherein the visual representation shows the user's progress towards achieving the one or more resource checkpoints.

16. The method of claim 15, wherein the visual representation comprises charts, graphs, or other visual elements that reflect completed and pending steps within the user-specific financial plan.

17. A computer program product for intelligent generation and tracking of resource checkpoints, the computer program product comprising a non-transitory computer-readable medium comprising code configured to cause an apparatus to:
aggregate, by a data aggregation subsystem, data from a user;
generate, using a generative artificial intelligence (AI) subsystem, an initial user-specific financial plan based on the aggregated data, wherein the initial user-specific financial plan comprises one or more resource checkpoints;
update, using the generative AI subsystem, the user-specific financial plan in response to user feedback to the initial user-specific financial plan;
continuously monitor, by a behavior monitoring subsystem, user actions and/or user behavior, and compare the user actions and/or user behavior to the user-specific financial plan; and
transmit, using a notification subsystem, preemptive notifications to the user based on detected patterns of user actions and/or user behavior, wherein the preemptive notifications comprise potential issues related to misalignment of user actions and/or user behavior with the resource checkpoints.

18. The computer program product of claim 17, wherein the data comprises zero-party data gathered directly from the user.

19. The computer program product of claim 17, wherein the data comprises user-provided financial goals.

20. The computer program product of claim 17, wherein the user feedback further enriches a user portfolio used to refine the user-specific financial plan.
